(19) United States
(12) Patent Application Publication
(10) Pub. No.: US 2014/0003046 A1
(43) Pub. Date: Jan. 2, 2014

(54) LIGHTING DEVICE AND LIGHTING SYSTEM

(71) Applicant: Ryotaro MATSUDA, Kanagawa (JP)

(72) Inventor: Ryotaro MATSUDA, Kanagawa (JP)

(73) Assignee: Toshiba Lighting & Technology Corporation, Kanagawa (JP)

(21) Appl. No.: 13/615,450

(22) Filed: Sep. 13, 2012

(30) Foreign Application Priority Data
Jun. 29, 2012 (JP) 2012-147256

(51) Int. Cl. F21V 7/00; F21V 29/00

(52) U.S. Cl. 362/235

(57) ABSTRACT

According to one embodiment, a lighting device includes a substrate, a reflector, and a housing. The substrate is mounted with light emitting elements. The reflector reflects light which is emitted from the light emitting elements. The housing supports the reflector in a state where an insulating layer is interposed between the substrate and the reflector by a support unit which is stretched from a installation surface on which the substrate is provided.

### CROSS-REFERENCE TO RELATED APPLICATION

This application is based upon and claims priority from prior Japanese Patent Application No. 2012-147256, filed on Jun. 29, 2012, the entire contents of which are incorporated herein by reference.

### FIELD

Embodiments described herein relate generally to a lighting device and a lighting system.

### BACKGROUND

In the related art, a spot light-type lighting device using a semiconductor light emitting element such as an LED (Light Emitting Diode) as a light source is used. In a spot light-type lighting device, for example, a plurality of LED chips of a surface mount type are aligned, and an arbitrary amount of light is obtained by the light distribution thereof being controlled by an optical lens or the like.

However, in a spot light-type lighting device, when a light source in which LED chips are arranged in a centralized manner is used, the structure of a reflector for controlling light distribution is apt to become large. In addition, in a surface mount-type LED, when a reflector structure with narrow light distribution and high efficiency is adopted, the optical control thereof tends to be increased. In addition, since each member comes into close contact with the other members when the lighting device itself is to be miniaturized, there is a concern that the lighting device may break down due to an electric connection of a substrate, for example, when the substrate comes into contact with other metal members.

### DESCRIPTION OF THE DRAWINGS

FIG. 1 is a perspective view which illustrates an appearance example of a lighting device according to an embodiment.

FIG. 2 is a side view which illustrates the appearance example of the lighting device.

FIG. 3 is a perspective view which illustrates an exploded example of the lighting device.

FIG. 4 is a vertical cross-sectional view which illustrates the lighting device.

FIG. 5 is a vertical cross-sectional view which illustrates a lighting device according to another embodiment.

FIG. 6 is an explanatory diagram which illustrates a lighting system according to the embodiment.

### DETAILED DESCRIPTION

In a lighting device 100 according to the embodiments to be described below, a substrate 150 is mounted with a light emitting element 151. A reflector 120 reflects light emitted from the light emitting element 151 and separated from the substrate by an insulator (an insulating layer). A housing 110 having an installation surface 110a on which the substrate 150 is provided. A support unit 112 extends from the installation surface 110a to support the reflector 120.

In addition, in the embodiments to be described below, the insulator is air and the substrate 150 and the reflector 120 are physically separated from each other.

In addition, in the embodiments to be described below, the insulator includes an insulating member 170 is attached to the substrate 150. In addition, the support unit 112 supports the reflector 120 such that the insulating member 170 is interposed between the substrate 150 and the reflector 120.

In addition, in the embodiments to be described below, the support unit 112 supports the center portion of the reflector 120 on the outer surface.

In addition, in the embodiments to be described below, the support unit 112 supports the reflector 120 by surrounding at least a part of the reflector 120.

In addition, in the embodiments to be described below, the support unit 112 supports the reflector 120 by being screwed to the outer surface of the reflector 120.

In addition, in the embodiments to be described below, the reflector 120 is formed of metal.

In addition, in the embodiments to be described below, the support unit 112 supports the reflector 120 such that a space which is formed between the housing 110 and the reflector 120 is sealed.

In addition, in the embodiments to be described below, a cover 130 is attached to the reflector 120, and seals a space which is formed within the reflector 120.

In addition, in the embodiments to be described below, the housing 110 includes a heat radiating fin 111 at a position corresponding to at least to the substrate 150 and at an outer surface 110b of the housing 110 which is opposite to the installation surface 110a.

In addition, in the embodiments to be described below, a lighting system 1 is provided with the lighting device 100, and is provided with two or more reflectors 120₁, 120₂, and 120₃ of which angles reflecting light which is emitted from the light emitting element 151 are different as the reflector 120.

Hereinafter, the lighting device according to the embodiments will be described with reference to drawings. In the embodiments, the same portions will be given with the same reference numerals, and repeated descriptions will be omitted.

Appearance example of lighting device

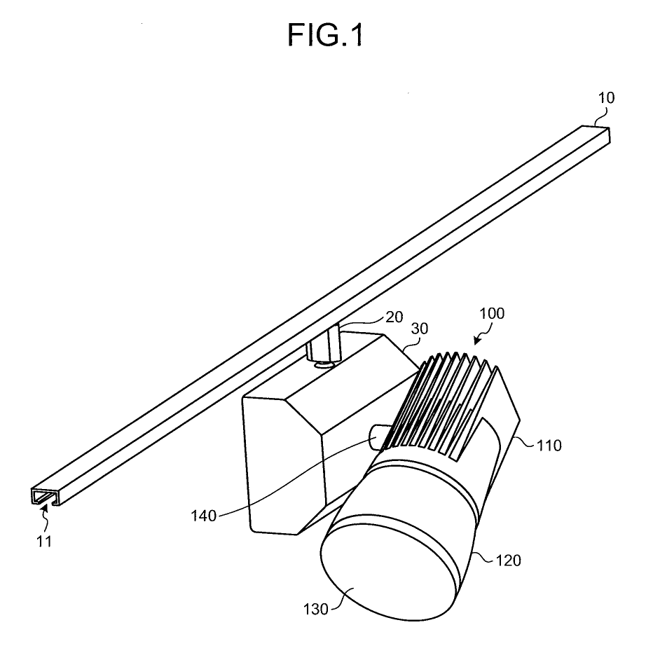

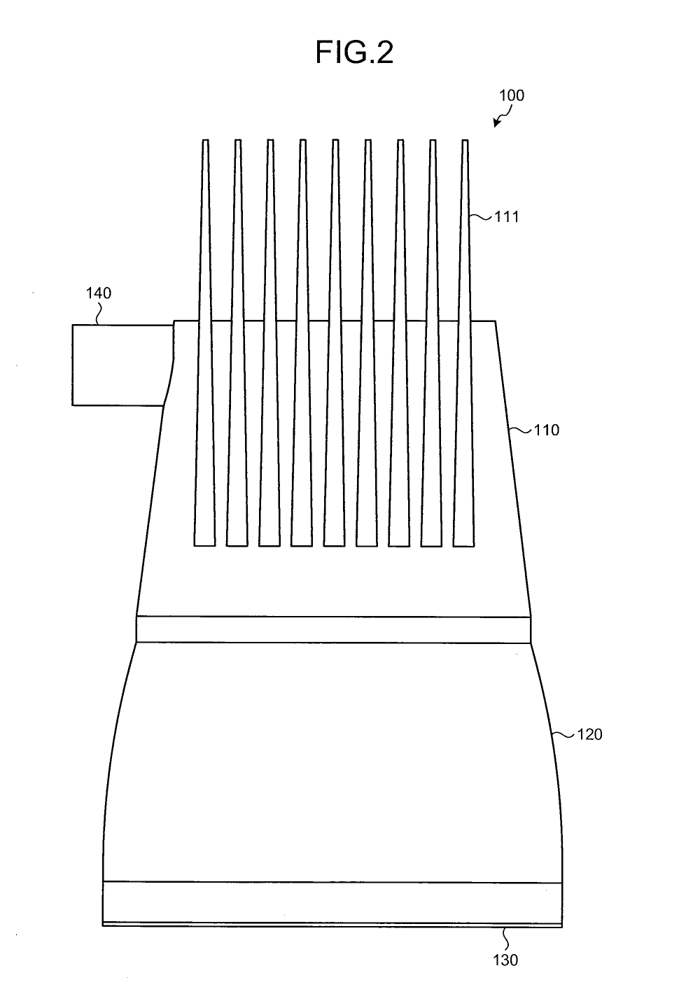

FIG. 1 is a perspective view which illustrates an appearance example of a lighting device according to an embodiment. FIG. 2 is a side view which illustrates the appearance example of the lighting device according to the embodiment. A lighting device 100 which is illustrated in FIGS. 1 and 2 is a spot light-type lighting device which is used in a house, a TV studio, a theater, or the like.

In the example in FIG. 1, a setting unit 10 is fixed to a ceiling, wall, or the like in a building. A slide ditch 11 is formed in the setting unit 10. One end of an arm 20 is attached to the slide ditch 11 in a swingable manner. In addition, a circuit component 30 is attached to the other end of the arm 20. The lighting device 100 is rotatably attached to the circuit component 30 through a fixing member 140. The circuit component 30 supplies an electric power which is supplied from a commercial AC power supply (not illustrated) to the lighting device 100, or performing a dimming control in the lighting device 100.

Such a lighting device 100 is able to move in the direction parallel to the slide ditch 11 by being integrated with the arm 20 when the arm 20 slides in the slide ditch 11. Further, the lighting device 100 is able to rotate by having the fixing member 140 as a rotation axis. In this manner, the lighting device 100 is able to light up a variety of directions.

In addition, as illustrated in FIGS. 1 and 2, the lighting device 100 includes a housing 110, a reflector 120, and a cover 130. The housing 110 is formed of metal with high thermal conductivity, and is molded by, for example, aluminum die-casting. A substrate (substrate 150 to be described later) on which light emitting elements (light emitting elements 151 to be described later) are mounted is provided in the housing 110. In addition, as illustrated in FIG. 2, heat radiating fins 111 for radiating heat which is generated from the light emitting elements outside are formed in the housing 110. In addition, a reference numeral 111 is attached to one heat radiating fin in an example illustrated in FIG. 2, however, each member having a flat plate shape which is formed in the housing 110 corresponds to the heat radiating fin 111.

The reflector 120 is made of synthetic resin, for example, such as ABS resin, or is made of metal such as aluminum die-casting, and performs a light distribution control by reflecting light which is emitted from the light emitting element in the housing 110. In addition, though it will be described later, the reflector 120 is supported by the housing 110 when the reflector is screwed to the housing 110.

The cover 130 covers the lower surface of the reflector 120 when being attached to the lower surface of the reflector 120. The cover 130 has a function of preventing dust or the like from coming into the reflector 120.

Exploded example of lighting device

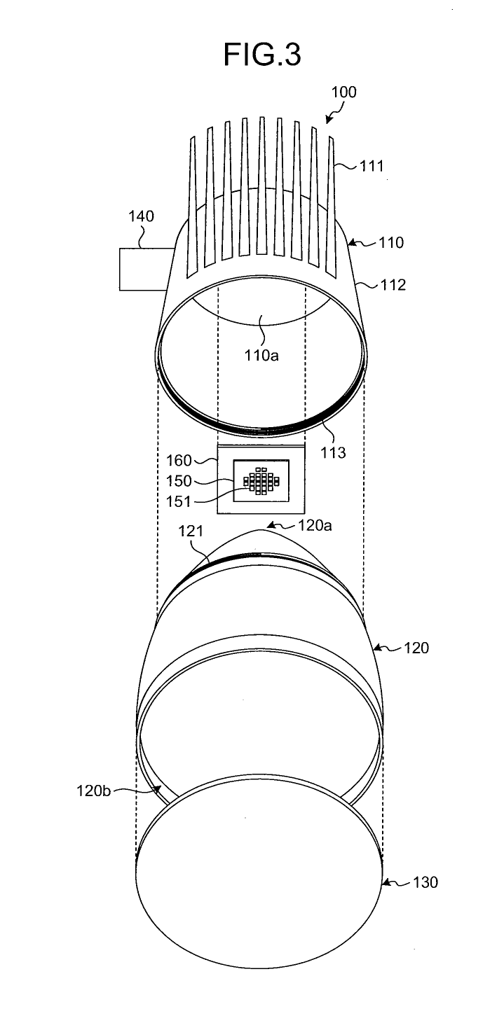

Subsequently, an exploded example of the lighting device 100 according to the embodiment will be described using FIG. 3. FIG. 3 is a perspective view which illustrates the exploded example of the lighting device 100 according to the embodiment. As illustrated in FIG. 3, the housing 110 is formed in an approximately columnar shape, and a shape of which the lower end portion is open. Specifically, the housing 110 includes a installation surface 110a, and a support unit 112 which is stretched from the peripheral edge portion of the installation surface 110a. That is, the installation surface 110a corresponds to a bottom wall of the housing 110 having the column shape, and the support unit 112 corresponds to a side wall of the housing 110 having the column shape. Such an installation surface 110a of the housing 110 is provided with the substrate 150 through an adhesion member 160.

The substrate 150 has an adhesive surface which is adhered to the adhesion member 160, and a mounting surface which is the opposite side to the adhesive surface. The mounting surface of the substrate 150 is mounted with the light emitting elements 151 such as LEDs or the like. In addition, in the example illustrated in FIG. 3, the reference numeral 151 is attached to one light emitting element, however, each member having a rectangular shape which is mounted on the mounting surface of the substrate 150 corresponds to the light emitting elements 151.

The adhesion member 160 is made of synthetic resin having high thermal conductivity, and is formed of a plane shape having a size which can be installed on the installation surface 110a of the housing 110. The adhesive member 160 can make the substrate 150 be in close contact with the housing 110 by being in close surface contact with both the installation surface 110a of the housing 110 and the substrate 150. In this manner, since the adhesion member 160 is able to effectively conduct the heat generated from the substrate 150 to the housing 110, it is possible to increase a heat radiation effect.

In addition, as illustrated in FIG. 3, the support unit 112 in the housing 110 includes a screwing unit 113 for supporting the reflector 120. The screwing unit 113 has a function of a “female screw”, and corresponds to a groove which is formed at the inner surface of the lower end portion in the support unit 112.

In addition, as illustrated in FIG. 3, the reflector 120 is formed of a cylinder shape of which the upper and lower ends are open in an approximately circular shape, respectively. The reflector 120 includes a screwing unit 121 for being screwed to the screwing unit 113 of the housing 110. The screwing unit 121 has a function of a “male screw”, and corresponds to a groove which is formed on the outer surface of the reflector 120. In addition, the screwing unit 121 is formed at the center portion which is present between an upper end opening portion 120a and a lower end opening portion 120b in the outer surface of the reflector 120. In other words, the screwing unit 121 is formed at a position other than an edge of the upper end opening portion 120a, and an edge of the lower end opening portion 120b.

In the lighting device 100 according to the embodiment, the support unit 112 supports the reflector 120 when the screwing unit 113 of the housing 110 and the screwing unit 121 of the reflector 120 are screwed to each other, and the reflector 120 is attached to the housing 110. That is, the reflector 120 according to the embodiment is attached to the housing 110 to be detachable therefrom.

The cover 130 is attached to the lower end opening portion 120b of the reflector 120. The cover 130 seals a space which is formed in the reflector 120.

Cross-sectional example of lighting device

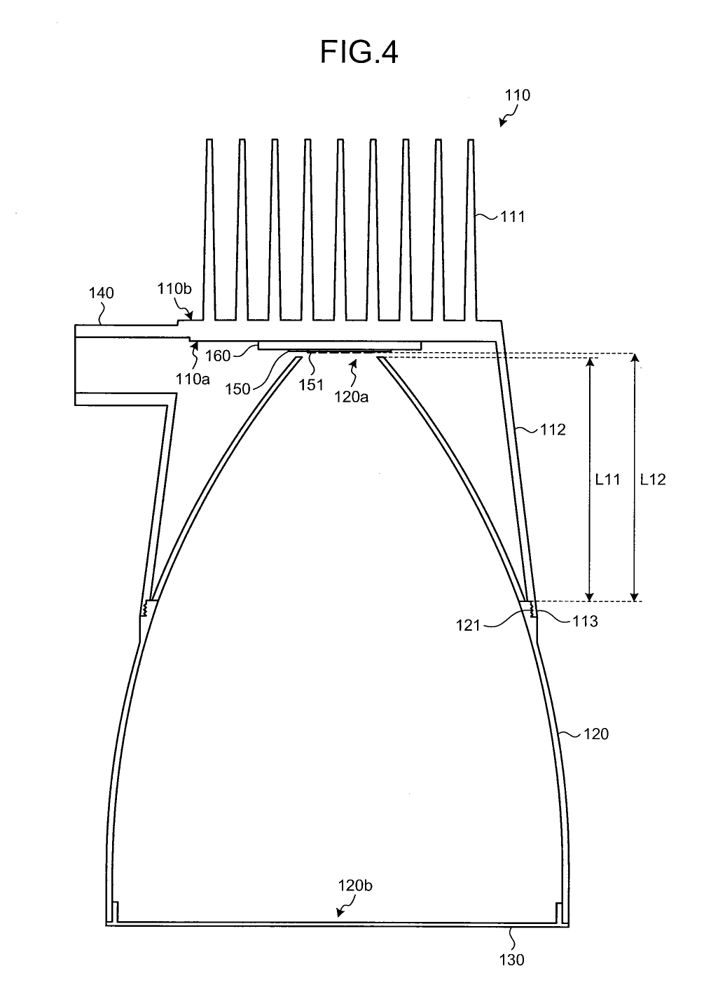

Subsequently, the cross-section of the lighting device 100 according to the embodiment will be described using FIG. 4. FIG. 4 is a vertical cross-sectional view which illustrates the lighting device 100 according to the embodiment. In addition, FIG. 4 illustrates a vertical cross section in a state where the reflector 120 is attached to the housing 110.

As illustrated in FIG. 4, the upper end opening portion 120a of the reflector 120 is provided at a position facing the light emitting elements 151 which are mounted on the substrate 150. In this manner, the reflector 120 adjusts light distribution by reflecting light which is emitted from the light emitting elements 151. Specifically, the light radiated from the light emitting elements 151 passes through the upper end opening portion 120a of the reflector 120, and reflects on the inner surface of the reflector 120. Accordingly, the radiation direction by the lighting device 100 is adjusted by the cylindrical shape of the reflector 120. In addition, FIG. 4 illustrates an example in which the reflector 120 is formed in a vertically long shape (a long shape from the upper end opening portion 120a to the lower end opening portion 120b), and the reflector 120 is a narrow angle type for illuminating a narrow range.

Here, the support unit 112 of the housing 110 supports the reflector 120 in a state where an insulating layer is interposed between the substrate 150 and the reflector 120. Specifically, the support unit 112 supports the reflector 120 in a state where the substrate 150 and the edge of the upper end opening portion 120a in the reflector 120 are separated from each other. That is, the support unit 112 is formed in a shape which is stretched from the installation surface 110a of the housing 110 so that a length L12 from the substrate 150 to the screwing unit 113 is longer than a length L11 from the upper end opening portion 120a of the reflector 120 to the screwing unit 121. In this manner, in the lighting device 100 according to the embodiment, the insulating layer due to air is formed between the substrate 150 and the reflector 120.

For example, when the reflector 120 is formed by metal such as the aluminum die-casting, there is a concern that the substrate 150 may break down, or the light emitting control in the substrate 150 may be hindered when the reflector 120 comes into contact with the substrate 150, and is electrically connected with the substrate 150. In addition, there is also a concern that the substrate 150 may break down when the surface of the substrate 150 is scratched or the like, when the reflector 120 comes into contact with the substrate 150. However, the lighting device 100 according to the embodiment is formed with the insulating layer between the substrate 150 and the reflector 120, it is possible to prevent the substrate 150 and reflector 120 from being electrically connected to each other, and as a result, it is possible to prevent the substrate 150 from breaking down.

In addition, as illustrated in FIG. 4, since the support unit 112 supports the screwing unit 121 which is formed at the center portion of the reflector 120, the support unit supports the reflector 120 in a state of surrounding at least a part of the reflector 120. In other words, the support unit 112 supports the reflector 120 in a state where at least a part of the reflector 120 is inserted into the housing 110. In this manner, in the lighting device 100 according to the embodiment, it is possible to realize downsizing of the lighting device 100 as a whole even when the reflector 120 is a large size.

In addition, since the support unit 112 supports the screwing unit 121 which is formed at the center portion of the reflector 120, not supporting the edge of the lower end opening portion 120b in the reflector 120, it is not necessary for the support unit to stretch from the installation surface 110a to the lower end opening portion 120b. For this reason, in the lighting device 100 according to the embodiment, it is possible to realize a weight reduction, since the support unit 112 can be miniaturized.

In addition, the support unit 112 supports the reflector 120 in a state where the space which is formed between the housing 110 and the reflector 120 is sealed by being screwed to the screwing unit 121. Further, the cover 130 seals the space which is formed in the reflector 120 by being attached to the reflector 120. In this manner, it is possible to prevent dust or the like from coming in, since the entire lighting device 100 is sealed. For example, in the lighting device 100 according to the embodiment, it is possible to prevent the substrate 150 from breaking down, since the substrate 150 can be prevented from being attached with the dust.

In addition, as illustrated in FIG. 4, on the outer surface 110b which is the opposite side to the installation surface 110a in the housing 110, the heat radiating fins 111 are formed at a position corresponding at least to the substrate 150. Further, as illustrated in FIGS. 1 to 3, the heat radiating fins 111 are formed in the support unit 112 of the housing 110, as well, so as to surround the substrate 150. In this manner, the lighting device 100 according to the embodiment is able to effectively radiate the heat which is generated from the substrate 150.

### Another Embodiment

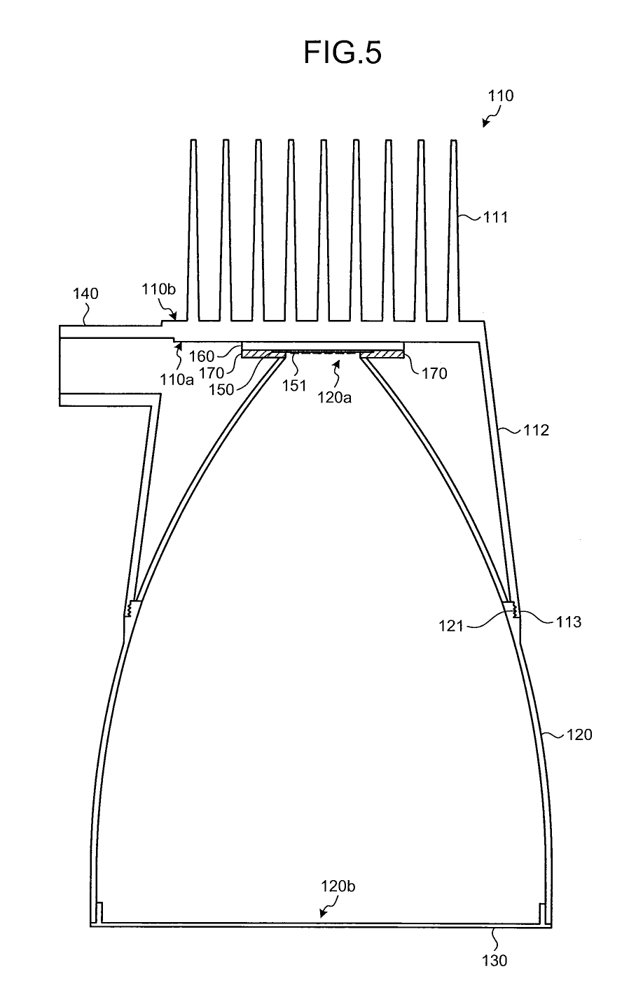

In the above described embodiment, an example was described in which the support unit 112 supports the reflector 120 in a state where the substrate 150 and the reflector 120 are separated from each other. That is, in the above described embodiment, an example was described in which the insulating layer as an air space is formed between the substrate 150 and the reflector 120. However, an insulating member such as resin may be attached to the substrate 150. This will be described using FIG. 5. FIG. 5 is a vertical cross-sectional view which illustrates a lighting device 100 according to the embodiment.

In the example illustrated in FIG. 5, an insulating member 170 such as resin is attached to a mounting surface of a substrate 150 on which light emitting elements 151 are mounted, in a region where the light emitting elements 151 are not mounted in the mounting surface of the substrate. In addition, a support unit 112 supports a reflector 120 in a state where the insulating member 170 is interposed between the substrate 150 and the reflector 120. At this time, the support unit 112 supports the reflector 120 in a state where an edge of an upper end opening portion 120a of the reflector 120 and the insulating member 170 come into contact with each other.

In this manner, it is possible to prevent the substrate 150 and the reflector 120 from being electrically connected even when the insulating member 170 is interposed between the substrate 150 and the reflector 120, and as a result, it is possible to prevent the substrate from breaking down. In addition, since a mounting surface of the substrate 150 is covered by the insulating member 170, it is possible to prevent wiring or the like on the substrate 150 from being exposed, and to improve design characteristics of the lighting device 100.

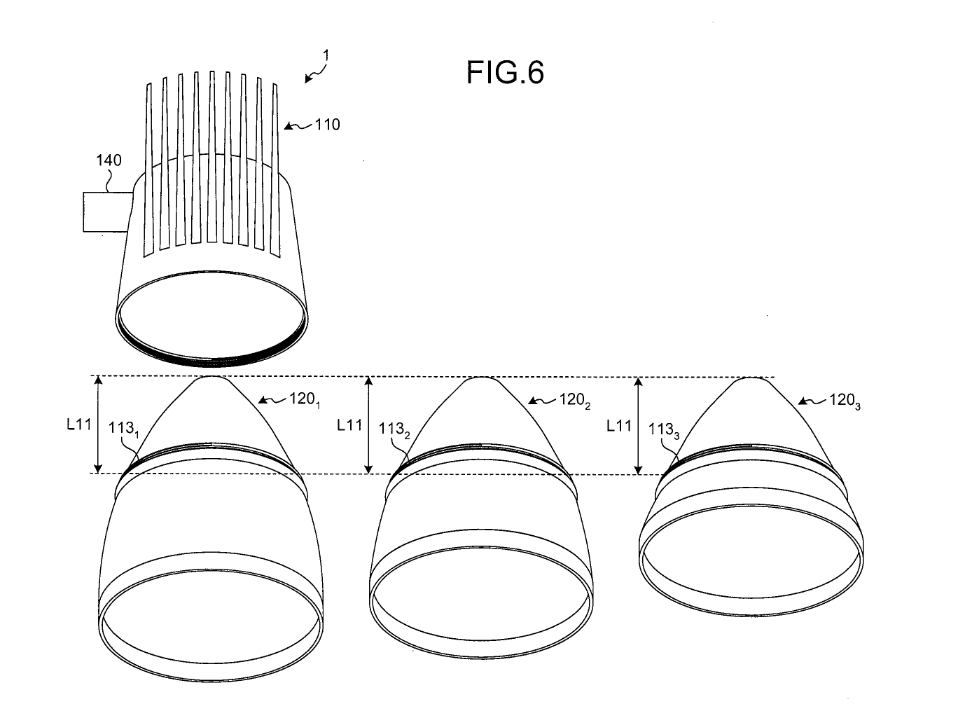

In addition, in the above described embodiment, a narrow angle-type reflector 120 for illuminating a narrow range was exemplified. However, the lighting device 100 may be attached with a variety of reflectors with different illumination ranges such as a wide angle-type reflector, and a middle angle-type reflector for illuminating a middle range between those of the narrow angle type and the wide angle type. This will be described using FIG. 6. FIG. 6 is an explanatory diagram which illustrates a lighting system according to the embodiment.

A lighting system 1 illustrated in FIG. 6 includes the above described lighting device 100. The lighting device 100 includes reflectors 120₁, 120₂, and 120₃ detachably. Each of the reflectors 120₁, 120₂, and 120₃ has a different angle of reflecting light which is emitted from the light emitting elements 151. Specifically, the reflector 120₁ is the narrow angle type for illuminating a narrow range, similarly to the above described reflector 120. In addition, the reflector 120₂ is the middle angle type for illuminating a middle range between those of the narrow angle type and the wide angle type. Specifically, the length from the upper end opening portion to the lower end opening portion in the reflector 120₂ is shorter than that in the reflector 120₁. In addition, the reflector 120₃ is the wide angle type for illuminating a wide range. Specifically, the length from the upper end opening portion to the lower end opening portion in the reflector 120₃ is further shorter than that in the reflector 120₂.

In this manner, in the lighting system 1 according to the embodiment, the plurality of reflectors having different light distribution ranges is detachably attached to the lighting device 100 and it is possible to easily change the illumination range due to the lighting device 100.

In addition, the lighting device 100 according to the embodiment supports the center portion of the reflector, not supporting the edge of the lower end opening portion in the reflector, even when the plurality of reflectors having the different length from the upper end opening portion to the lower end opening portion is attached, it is possible to support the reflector in a state where the insulating layer is interposed between the respective reflector and the substrate 150. Specifically, in the example illustrated in FIG. 6, the reflector 120₁ is formed to have approximately the same length as the length L11 illustrated in FIG. 4 from the upper end opening portion to a screwing unit 113₁. Similarly, the reflector 120₂ is formed to have the length L11 from the upper end opening portion to a screwing unit 113₂, and the reflector 120₃ is formed to have the length L11 from the upper end opening portion to a screwing unit 113₃. In this manner, when the support unit 112 of the housing 110 supports the reflectors 120₁, 120₂, and 120₃, it is possible to interpose the insulating layer between the reflectors 120₁, 120₂, 120₃ and the substrate 150. That is, in the lighting system 1 according to the embodiment, it is possible to attach the plurality of reflectors having different light distribution ranges to the lighting device 100 detachably, and to prevent each of the reflectors and the substrate 150 from being electrically connected to each other.

In addition, in the example illustrated in FIG. 6, the lighting system 1 having three types of reflectors was exemplified. However, the lighting system 1 may include two types of reflectors having different reflecting angles, and may include reflectors of four types or more.

In addition, in the above described embodiment, a spot light type was exemplified, however, the lighting device 100 can be applied to a down-light-type lighting device or the like which is installed by being embedded into a ceiling, in addition to the spot light type.

In addition, it is not necessary for the lighting device 100 according to the embodiment to include all of the members in the embodiment, or those which are denoted in each drawing. For example, the lighting device 100 may include the fixing member 140.

In addition, the shape, raw materials, and material of each member according to the embodiment are not limited to the embodiments, or to the examples denoted in each drawing. For example, the housing 110, the reflector 120, the cover 130, or the like may have a rectangular shape instead of the circular shape . In addition, for example, the substrate 150 or the like may have a circular shape, not the rectangular shape.

As described above, according to the embodiments, it is possible to realize a miniaturized lighting device and lighting system in which the breakdown of the substrate is prevented.

Some embodiments was described, however, the embodiments are merely examples, and do not limit the scope of the invention. It is possible to embody these new embodiments, or examples in a variety of embodiments other than that, and the embodiments may be omitted, substituted, changed without departing from the scope of the invention. These embodiment, examples, or the modification examples are included in the scope, or gist of the invention, and included in the invention disclosed in claims, and equivalent claims thereof.

What is claimed is:

1. A lighting device comprising:
a substrate on which light emitting elements are mounted;
a reflector configured to reflect light emitted from the light emitting elements and separated from the substrate by an insulator;
a housing having an installation surface on which the substrate is provided; and
a support unit that extends from the installation surface to support the reflector.

2. The device according to claim 1, wherein the insulator is air and the substrate and the reflector are physically separated from each other.

3. The device according to claim 1, wherein the insulator comprises an insulating member which is attached to the substrate, and the support unit supports the reflector such that the insulating member is interposed between the substrate and the reflector.

4. The device according to claim 1,
wherein the support unit supports a center portion of an outer surface of the reflector.

5. The device according to claim 1,
wherein the support unit supports the reflector by surrounding at least a part of the reflector.

6. The device according to claim 1,
wherein the support unit supports the reflector by being screwed to an outer surface of the reflector.

7. The device according to claim 1,
wherein the reflector is formed of metal.

8. The device according to claim 1,
wherein the support unit supports the reflector such that a space formed between the housing and the reflector is sealed.

9. The device according to claim 1, further comprising:
a cover which is attached to the reflector, and covers a space formed within the reflector.

10. The device according to claim 1,
wherein the housing includes heat radiating fins at a position corresponding to at least the substrate and at an outer surface of the housing which is opposite to the installation surface.

11. A lighting system comprising:
first and second lighting devices each including a substrate on which light emitting elements are mounted, a reflector configured to reflect light emitted from the light emitting elements and separated from the substrate by an insulator, a housing having an installation surface on which the substrate is provided, and a support unit that extends from the installation surface to support the reflector,
angles of light emitted from the light emitting elements of the first and second lighting devices as reflected by the reflectors of the first and second lighting devices are different.

12. A lighting device comprising:
at least one light emitting element;
a substrate on which said at least one light emitting element is mounted;
a reflector configured to reflect light emitted from said at least one light emitting element; and
a frame that supports the substrate and the reflector, the substrate being mounted on a first portion of said frame and the reflector being mounted on a second portion of said frame, the substrate and the reflector being separated by an insulator.

13. The device according to claim 12, wherein the insulator is air and the substrate and the reflector are physically separated from each other.

14. The device according to claim 12, wherein the insulator comprises an insulating member which is attached to the substrate, and the frame supports the reflector such that the insulating member is interposed between the substrate and the reflector.

15. The device according to claim 14, wherein the frame includes an extension that supports a center portion of an outer surface of the reflector.

16. The device according to claim 12, wherein the frame is screwed to an outer surface of the reflector.

17. The device according to claim 12, wherein the reflector is formed of metal.

18. The device according to claim 12, wherein the frame supports the reflector such that a space formed between the frame and the reflector is sealed.

19. The device according to claim 12, further comprising a cover which is attached to the reflector, and covers a space formed within the reflector.

20. The device according to claim 12, further comprising heat radiating fins attached to a surface of the frame that is opposite to a surface that supports the substrate and the reflector.
